(19) United States
(12) Patent Application Publication
(10) Pub. No.: US 2014/0209581 A1
(43) Pub. Date: Jul. 31, 2014

(54) LIGHT CONCENTRATOR OR DISTRIBUTOR

(71) Applicant: Schott AG, Mainz (DE)

(72) Inventors: Edgar Pawlowski, Stadecken-Elsheim (DE); Wolfram Beier, Essenheim (DE)

(73) Assignee: Schott AG, Mainz (DE)

(21) Appl. No.: 14/166,883

(22) Filed: Jan. 29, 2014

(30) Foreign Application Priority Data
Jan. 29, 2013 (DE) 10 2013 100 888.7

(51) Int. Cl. G02B 27/12; B23K 26/36; G02B 27/10

(52) U.S. Cl. CPC G02B 27/12; G02B 27/1073; B23K 26/365
USPC 219/121.69; 359/639; 250/227.11; 359/619; 362/230; 362/84; 216/24; 219/121.68

(57) ABSTRACT

A light concentrator or distributor is provided, which includes a plurality of light conducting cells that are lined up in a transparent light conducting body. The light conducting cells are defined by boundary faces, which are produced within the light conducting body using laser radiation.

### CROSS REFERENCE TO RELATED APPLICATIONS

This application claims benefit under 35 U.S.C. §119(a) of German Patent Application No. 10 2013 100 888.7, filed Jan. 29, 2013, the entire contents of which are incorporated herein by reference.

### BACKGROUND OF THE INVENTION

1. Field of the Invention

The invention relates to a light concentrator or distributor, in particular of glass, glass ceramics, opto-ceramics, or crystal, for focusing light onto a plurality of light receiving elements or for spreading and collimating light from small area light sources, and also relates to a device including a light source or a photo detector or a photovoltaic cell, and a light concentrator or distributor, and also relates to methods and apparatus for producing such light concentrators or distributors.

The term “light” in the context of the invention does not only refer to visible light, but also to infrared light, ultraviolet light, and X-ray light, if such light is intended to be used with the light concentrator or distributor.

2. Description of Related Art

In the field of concentrator photovoltaics (CPV) light concentrators are required to direct focused sunlight onto small areas of photovoltaic cells. In fact, to some extent the efficiency of photovoltaic cells is higher with an increased concentration of sunlight than with natural sunlight. Typical light concentrators include lenses and/or truncated cone shaped diffractive optical elements which are used as frontal attachment elements on grid arrays of photovoltaic cells. The attachment elements may have a rod shape, and in this case they are produced in a pressing process and are polished.

Examples of light concentrators that are used as frontal attachment elements of solar cells can be found in WO 12/046376 A, WO 11/081090 A, CN 102109670 A, JP 2010212280 A, US 2010/024867 A, CN 201289854 Y, CN 101355114 A, CN 101192632 A, US 2002/148497 A, U.S. Pat. No. 6,051,776 A, and JP 2000022194 A. In these known elements, the optical function of concentration of light is determined by the geometric outer shape of the elements which mostly have a funnel-shaped design in cross section. Therefore, specifically adapted support structures are required for photovoltaic systems, which are difficult to be integrated in roof surfaces, because of difficulties in sealing against rain.

A “light distributor” in the context of the invention refers to a light concentrator assembly in which the light passes through the assembly in the opposite direction so to say.

WO 00/71929 A1 discloses an optical element for deflecting light rays and a method for producing same. The optical element comprises a transparent plate with pyramidal profiled portions arranged in rows and columns, between which furrows extend which are covered by a foil having a reflective grid layer. Light rays incident upon the optical element are deflected, and the re-emerging light rays are limited in the angle at which they emerge. The optical behavior of the optical element depends on the pyramidal profiled portions which define the geometrical outer contour of the transparent plate.

EP 2 487 409 A1 describes a reflector for lighting purposes which has totally reflecting facets or surfaces embedded in a transparent base body, which were produced by laser engraving. Specifically, the totally reflecting surfaces are inclined relative to the optical axis of the base body and are distributed around this optical axis.

An illumination system for a liquid crystal display panel is known from U.S. Pat. No. 4,915,479. Truncated pyramids or truncated paraboloids are disposed adjacent to one another, and their geometrical outer contour determines the optical function of the illumination system.

Application of laser engraving for producing diffraction gratings and reflective surfaces is widely known (US 2012/0039567 A1, WO 2011/154701 A1, DE 101 55 492 A1, and DE 10 2011 017 329 A1). By laser engraving, the refraction index in the volume of a transparent material can be modified. In this way, waveguides can be produced which are surrounded by material of a modified refraction index.

### SUMMARY

The invention is based on the object to provide light concentrators or distributors whose optical function is not solely defined by their geometric outer shape. Desirably, the light concentrator or distributor is to be produced in form of rods or plates which can be used as structural elements (supporting components in constructions). When used as a concentrator, the light should be directed onto a photovoltaic cell or another light receiving element in a concentrated and yet very uniformly (homogeneously) distributed manner. When used as a light distributor, the light emanating from small area light sources such as LEDs, OLEDs, or lasers should be provided in a manner uniformly distributed over larger areas.

In particular, in order to achieve the object of the invention, a transparent light conducting body is provided, which may be made of organic or inorganic transparent dielectric material and which may have an outer shape of a rod or plate, and which has a plurality of inner boundary faces in the interior thereof, which define a plurality of light conducting cells. These light conducting cells have a major and a minor base, as given in truncated pyramids, truncated cones, or truncated paraboloids. The lateral surfaces of these stubs define the inner boundary faces in the light conducting body, which direct the light onto the minor or the major base of the stub, depending on the direction of passage, by diffraction, reflection, or total reflection. The boundary faces formed within the light conducting body comprise inner surfaces with locally strongly modified refraction index, or dot-shaped or nanocrack-like structuring elements which are smaller, as seen in the direction of light propagation, than the light wavelength of the operating light which is intended to be used with the light concentrator or distributor when being employed. By having the inner boundary faces extending obliquely to the direction of the incident or emitted light, at least reflection, or total reflection for larger angles of incidence to the vertical, will occur at these boundary faces and thus deflection toward the respective base of the light conducting cell.

The structuring elements of the inner boundary faces may comprise surfaces with locally modified refraction index, or very small volume elements, virtually zero-dimensional elements which are referred to as dot positions herein, such as can be produced by focused laser radiation. Such dot positions have an inner region of increased refraction index and an outer region of reduced refraction index, all smaller than the wavelength of the light employed. With a spacing of the dot positions smaller than the wavelength of the employed light, reflection will be caused at the inner boundary face spanned by the dot positions.

The structuring elements of the inner boundary faces may also comprise nanocracks, quasi one-dimensional structures, such as can be produced by focused laser radiation of high beam quality and with good microscope objective lenses (NA>0.8) at wavelengths of e.g. 180 to 2000 nm. The nanocracks are sufficiently small as compared to the operating wavelength, so that they will cause the operating light to be diffracted, refracted, or totally reflected, but not predominantly scattered, as would be the case with microcracks.

Finally, the structuring elements of the inner boundary faces may also comprise 2-dimensional wall structures of 3-dimensional channels such as can be produced by removal of material using etching processes (chemical or physical), or by laser. Here again, surfaces of low roughness and therefore with little scattering effect are beneficial. For this purpose, the channels may be enlarged by machining (cutting, grinding, or polishing) to produce narrow air gaps.

The material of the light conducting bodies is chosen according to the intended use of the light concentrators or distributors. Often glass, glass ceramics, opto-ceramics, or crystal is used in form of rods or plates. These are durable, solarization-resistant and chemically stable materials, and the outer shape of the light conducting bodies may be produced by an inexpensive process, e.g. a hot molding process directly from the melt, or in case of the opto-ceramics by compressing ceramic nano-powders and a subsequent sintering step. If plastics are used, the outer shape of the light conducting bodies can be produced cost efficiently by injection molding, heat molding, blow molding, or by special thermoforming processes. Lens shapes may be produced by known techniques as the light entry and light exit surfaces of the light conducting cells, complementing the optical function of the inner boundary faces. The light conducting bodies may be provided in any desired outer contour by an extrusion process, rolling process, hot embossing process, or cold processing method (grinding or polishing), and subsequently one or more rows of light conducting cells are produced in the interior of the light conducting body.

### BRIEF DESCRIPTION OF THE DRAWINGS

Further details of the invention will become apparent from the following exemplary embodiments in conjunction with the drawings. In the drawings:

FIG. 1a shows a rod- or strip-shaped light concentrator with a line of light conducting cells;

FIG. 1b shows a rod- or strip-shaped light concentrator with a line of light conducting cells with lenses;

FIG. 1c shows a rod- or strip-shaped light concentrator with several lines of light conducting cells forming a light conducting array;

FIG. 1d shows a rod- or strip-shaped light concentrator of trapezoidal shape including one line of light conducting cells;

FIG. 1e shows a rod- or strip-shaped light concentrator including one line of light conducting cells with cylindrical lens;

FIG. 1f shows a rod- or strip-shaped light concentrator with cylindrical lens and comprising a line of light conducting cells, and light emitters (LEDs, OLEDs, or lasers), or photodetectors, or photovoltaic cells;

FIG. 1g shows a rod- or strip-shaped light concentrator with convex and concave lenses, and comprising a line of light conducting cells, and light emitters (LEDs, OLEDs, or lasers), or photodetectors, or photovoltaic cells;

FIG. 2 illustrates individual shapes of light conducting cells;

FIG. 3 is a longitudinal section through a light conducting cell;

FIG. 4 illustrates the optical light intensity function including 8 maxima at the bottom of the light conducting cells;

FIG. 5 illustrates a first scheme for producing light conducting cells with locally modified refraction index of inner boundary faces;

FIG. 6 illustrates another scheme for producing light conducting cells with nanocracks to form inner boundary faces; and

FIG. 7 illustrates yet another scheme for producing light conducting cells with channels to form the inner boundary faces.

### DETAILED DESCRIPTION

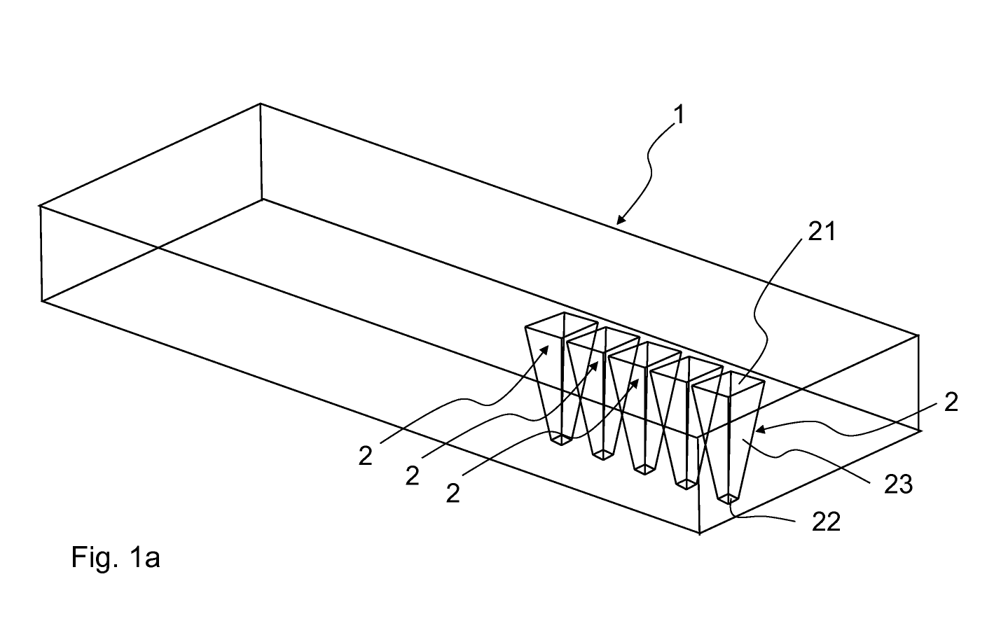

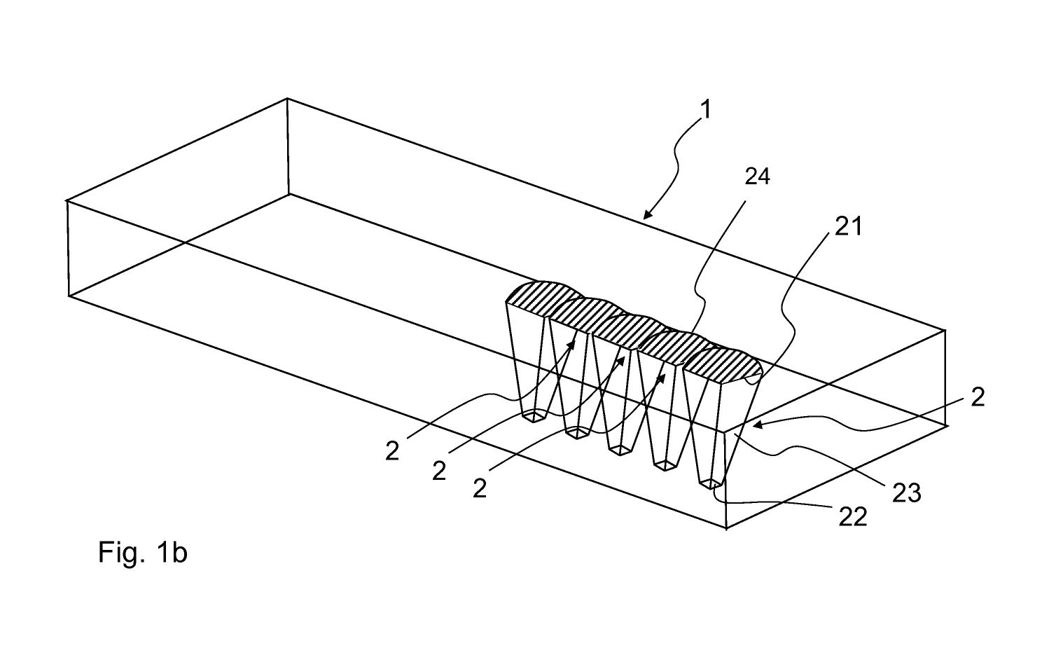

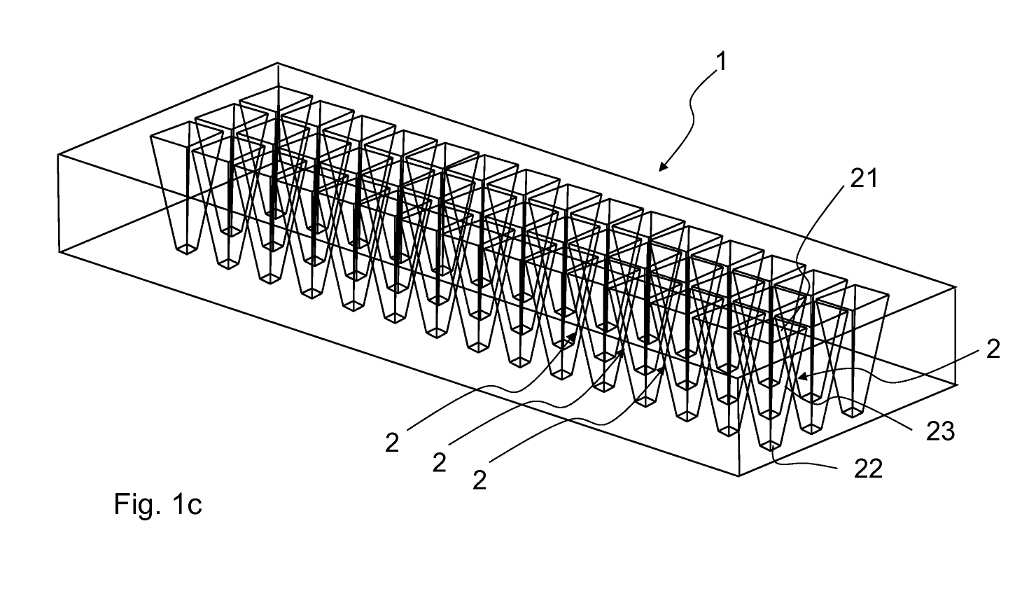

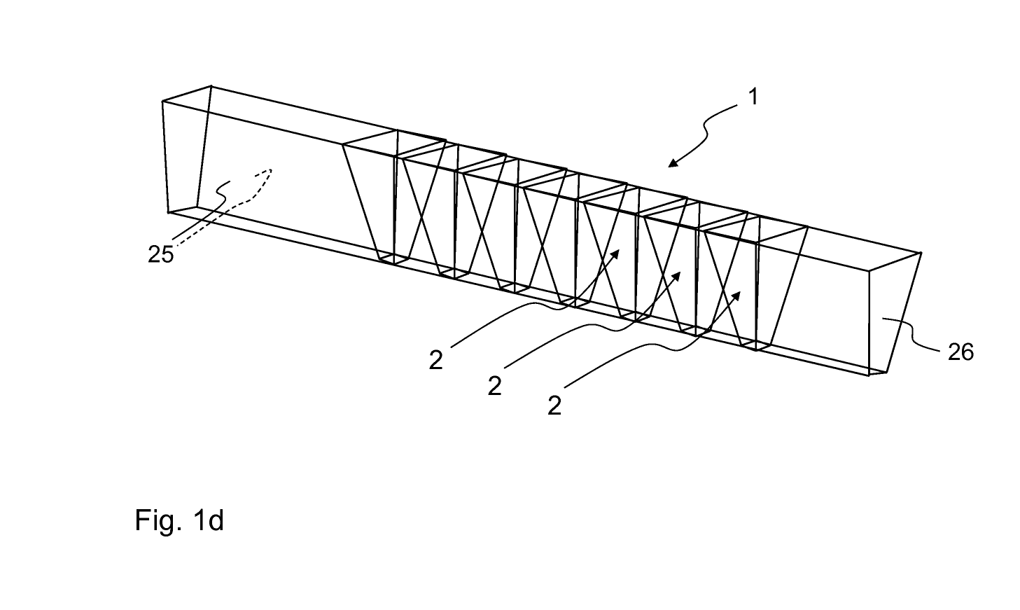

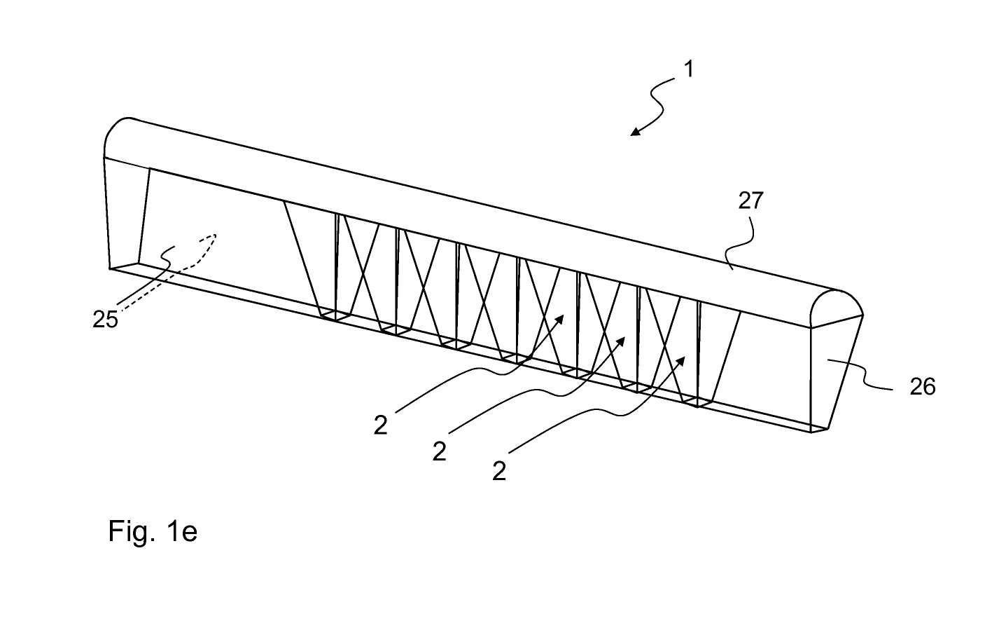

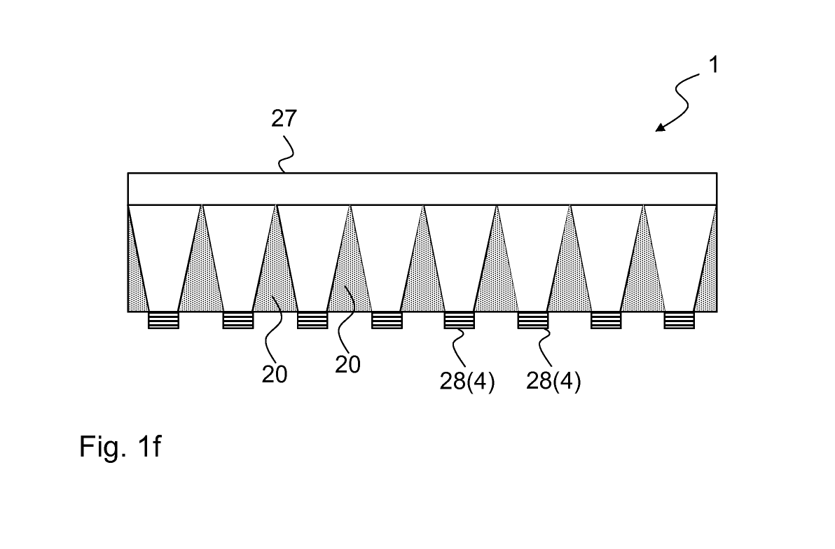

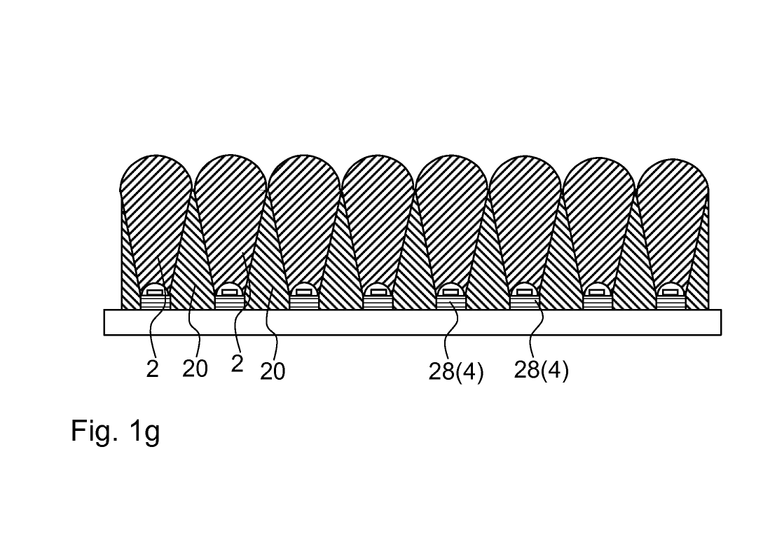

FIG. 1a is a perspective view of a light concentrator formed as a cell array. A light conducting body 1 of a transparent dielectric material has an upper surface as a light entrance side and a lower surface as a light exit side. Within light conducting body 1, a number of light conducting cells 2 is arranged side by side and forms a linear array of light conductors. Light conducting cells 2 have a shape of truncated pyramids having a major base 21 and a minor base 22 and inclined surfaces as lateral surfaces 23. Bases 21 and 22 may be aligned with the upper or lower surfaces of light conducting body 1, but need not. It is also possible that the minor and/or major base(s) is/are arranged in the interior of the light conducting body, adjacent to the upper and lower surfaces. The following dimensions are possible for light conducting cells 2: edge of major base: from 1 to 100 mm, preferably from 2 to 25 mm; edge of minor base: from 0.2 to 50 mm, preferably from 0.4 to 5 mm, height of the light conducting cells: from 0.1 to 50 mm, preferably from 1 to 10 mm; ratio of the edges of the bases: from 1 to 10, preferably from 3 to 6.

The light conducting body may have a length and width in a range from 10 to 2000 mm (preferably from 50 to 200 mm), and a height in a range from 0.1 to 50 mm (preferably from 1 to 10 mm), i.e. it may be provided in form of a plate that includes a plurality of lines of light conducting cells 2.

Unlike the flat surfaces illustrated in FIG. 1a, the upper and lower surfaces of the light conducting body may have a surface structure that extends above light conducting cells 2 and has a light collecting function to bring more light into the respective associated light conducting cell. In this context, FIG. 1b shows a perspective view of a light concentrator formed as a cell array. The light collecting function may be realized by a curved surface 24 of spherical, aspherical, or free shape above each individual light conducting cell 2.

FIG. 1c is a perspective view of a light concentrator in form of a 2-dimensional cell array.

FIG. 1d is a perspective view of a light concentrator in form of a 1-dimensional cell array. Lateral surfaces 25 converge toward each other. The cross-section 26 is trapezoidal in shape. Unlike in the illustration, the lateral surfaces may also have a parabolic shape.

FIG. 1e is a perspective view of a light concentrator in form of a 1-dimensional cell array with a cylindrical lens 27.

FIG. 1f shows a rod- or strip-shaped light concentrator including a line of light conducting cells with a cylindrical lens 27 and light emitters 28 (LEDs, OLEDs, or lasers), or with photodetectors or photovoltaic cells 4.

Photovoltaic cells that can be used include organic and inorganic thin film cells, crystalline cells, and multiple cells. Between respective light conducting cells 2, there is a wedge-shaped interspace 20 filled with air or with a filling material whose refraction index is smaller than the refraction index of the material of the light conducting cells 2.

FIG. 1g shows a rod- or strip-shaped light concentrator including a line of light conducting cells with convex and concave lenses at the upper and lower surfaces, respectively, of each light conducting cell 2, and with light emitters 28 (LEDs, OLEDs, or lasers), or with photodetectors or photovoltaic cells 4 upon a heat sink.

If the light conducting body 1 is operated with a light emitter 28 at the minor base 22, one can speak of an illumination device which emits useful light through the major base 21 or through a lens 24 or 27.

It is also possible to obtain the useful light by light conversion. In such a case a transparent dielectric material is used, which is doped with a light converting or fluorescent material and which transmits 50% or more of the light from the light emitter and absorbs or converts the remainder.

If the light conducting body of FIGS. 1f, 1g includes photodetectors or photovoltaic cells 4 and is subjected to outside light, e.g. sunlight, one can speak of a light receiving device or photovoltaic device. With such devices, rod-shaped and plate-shaped configurations of light conducting bodies 1 may advantageously be used.

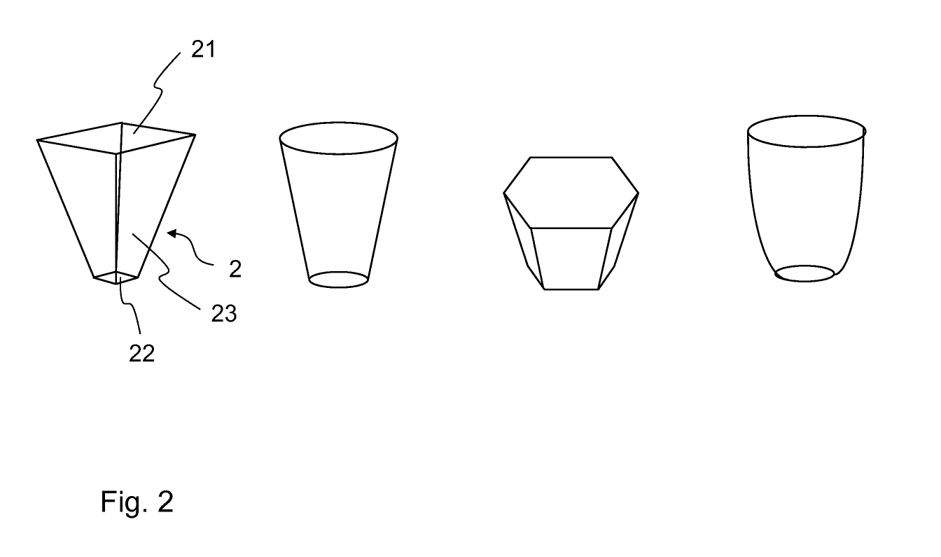

FIG. 2 illustrates several possible shapes of light conducting cells 2, including a truncated pyramid, a truncated cone, a conical honeycomb, and a truncated paraboloid.

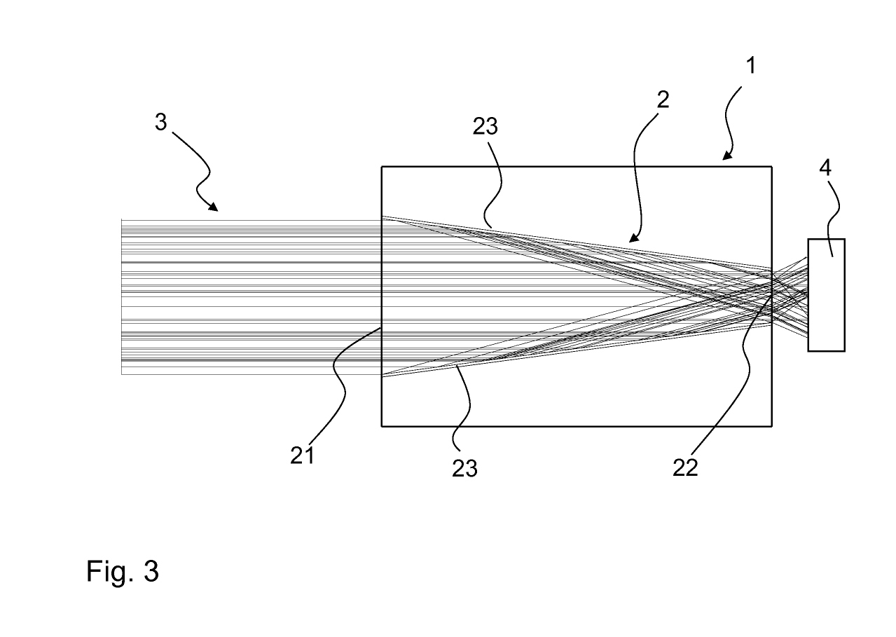

FIG. 3 shows a longitudinal section through a light conducting cell 2 in conjunction with a light beam 3 which enters at base 21 of the light conducting cell, is reflected at the inclined lateral surfaces 23, and exits at the minor base 22. A photovoltaic cell 4 of the photovoltaic system may be located directly after minor base 22. If the major base 21 is of a size A and the minor base is of a size a, the light intensity incident on the photovoltaic cell is increased by a factor of A/a.

It will be understood that the light conducting cell 2 may be used in the opposite direction, with minor base 22 as a light entrance surface and major base 21 as a light exit surface. Such an arrangement may be useful as an illumination field.

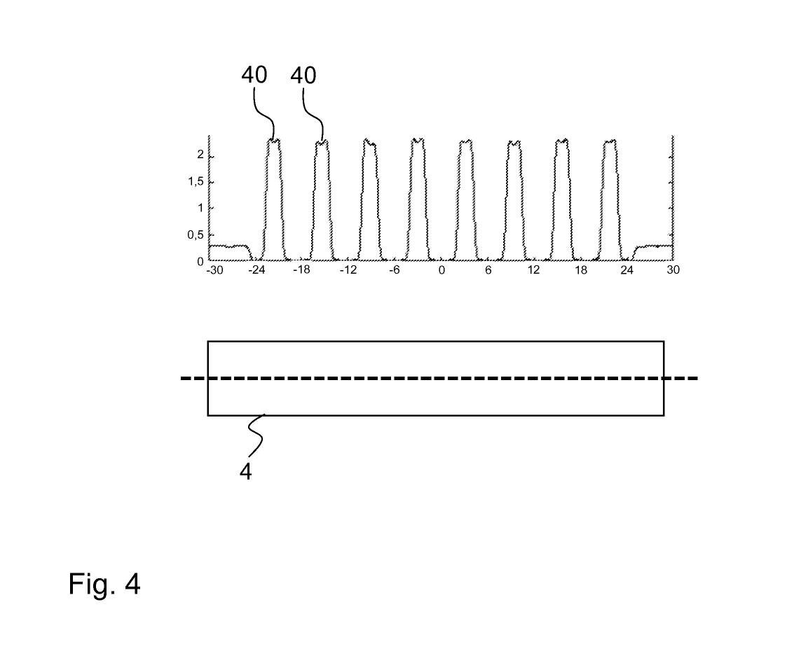

FIG. 4 shows the effect of a line of light conducting cells irradiated with light to a photovoltaic cell or a detector 4 whose detected current is illustrated. Incident light passes through the light conducting body including the light conducting cells and occurs in concentrated form at the minor bases of the light conducting cells. Each light conducting cell has associated therewith a light exit cone with a fairly flat top. This is reflected in the course of detected current 40.

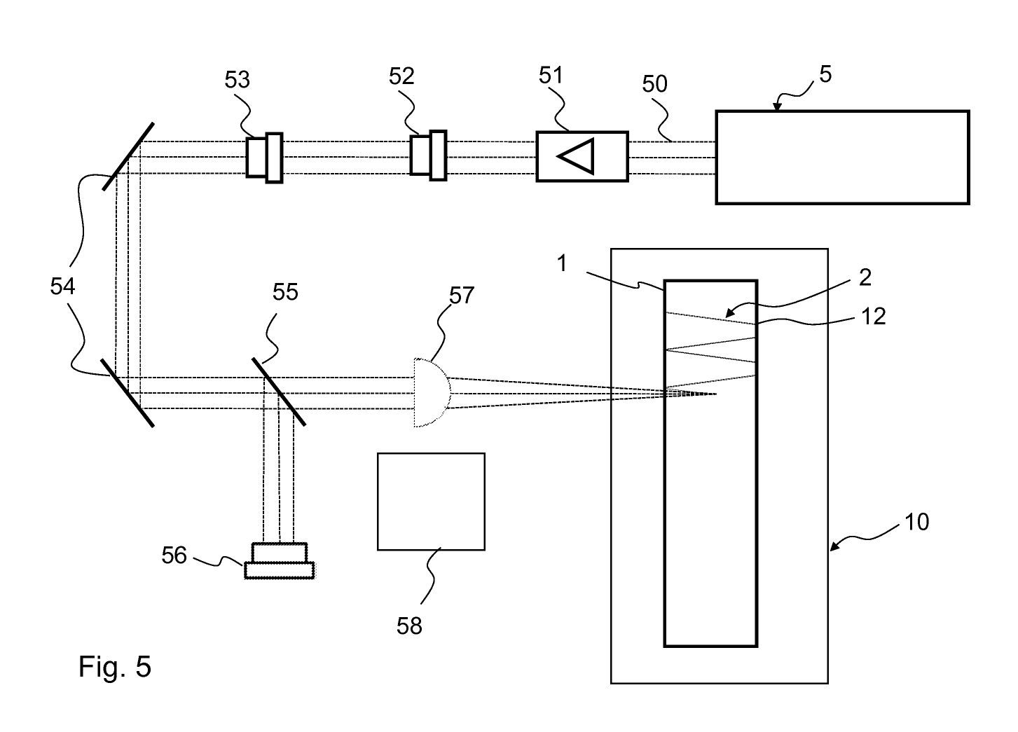

FIG. 5 illustrates a system for producing a light concentrator or distributor. A laser 5, e.g. a titanium-sapphire laser (Ti:Al₂O₃ laser) having a pulse width of less than 100 fs and a wavelength of about 850 nm is operated in mode-locked state and emits its radiation 50 to a beam splitter 55, via an optical diode 51, a λ/2 plate 52, and a polarizer 53, and optionally via a deflection system 54, which beam splitter 55 deflects a minor power portion to a power meter 56 and supplies a major power portion to a microscope objective lens 57 (parameters: 100×, NA: 0.8). The laser radiation is focused within light conducting body 1 which is placed in a workpiece holder 10, as a workpiece. Workpiece holder 10 is fine adjustable in the x-, y-, and z-directions relative to microscope objective lens 57. For this purpose, 3D piezoelectric actuator motors may be used with precision roller bearings and linear guides. The measuring device is an interferometric device. When using such displacement means, repeatability of better than 2 nm can be achieved. A control means 58 is connected to laser 5, power meter 56, and workpiece holder 10 for controlling and regulating the processing of light conducting body 1. Other lasers having a pulse width of less than 1 ps and a wavelength in a range from 180 nm to 2000 nm may also be used.

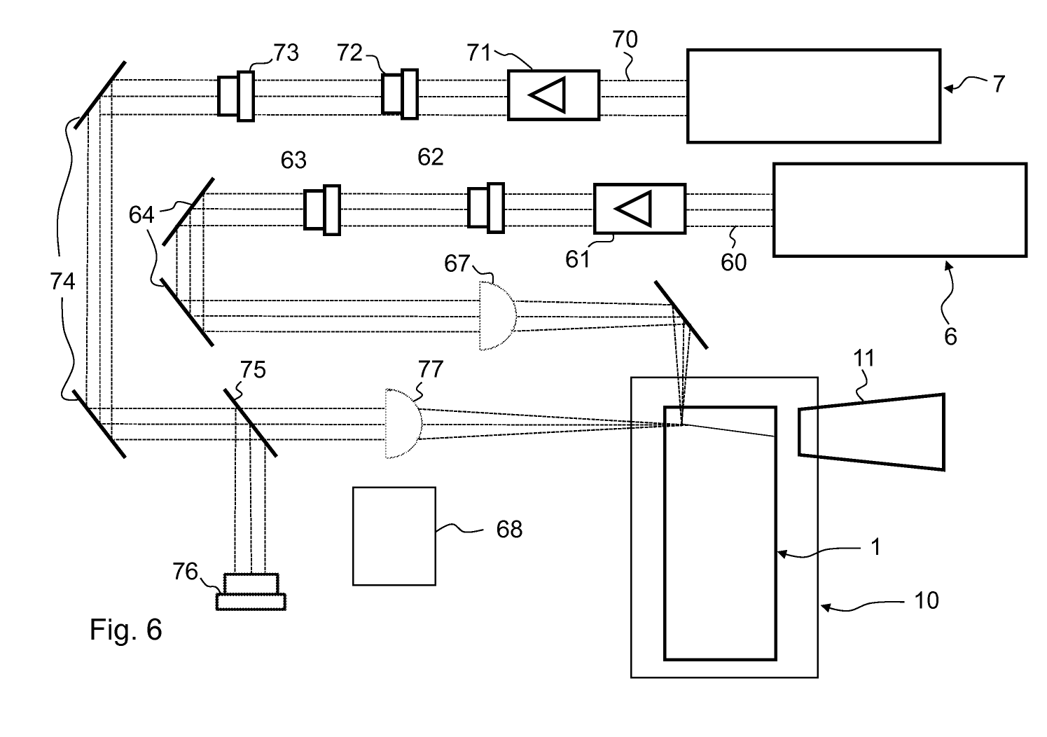

FIG. 6 shows another scheme of processing of a light conducting body 1 for producing a light concentrator. Two lasers 6 and 7 are provided for emitting laser radiation 60 and 70, respectively, of high beam quality M<2, which is supplied to a respective microscope objective lens, 67 and 77, (parameters: 100×, NA>0.8) via optical diodes, 61 and 71, respectively, λ/2 plates, 62 and 72, respectively, polarizers, 63 and 73, respectively, and deflection systems 64 and 74, respectively, which objective lenses focus on a dot position in light conducting body 1. Further, a control means 68 is provided which controls lasers 6, 7, a power meter 76, and fine adjustable workpiece holder 10. In the region of workpiece holder 10 a suction device 11 may be provided. Laser 6 is a neodymium-garnet laser (Nd:YAG laser), for example, which may be operated frequency tripled at a wavelength of 354.6 nm with a pulse width of 1 ps. Laser 7 is an XeF laser, for example, having an operating wavelength of 351 nm and a possible pulse width of 1 ps. Other types of lasers in a wavelength range from 180 nm to 2000 nm may also be used. Advantageously, the wavelengths of the two lasers are different.

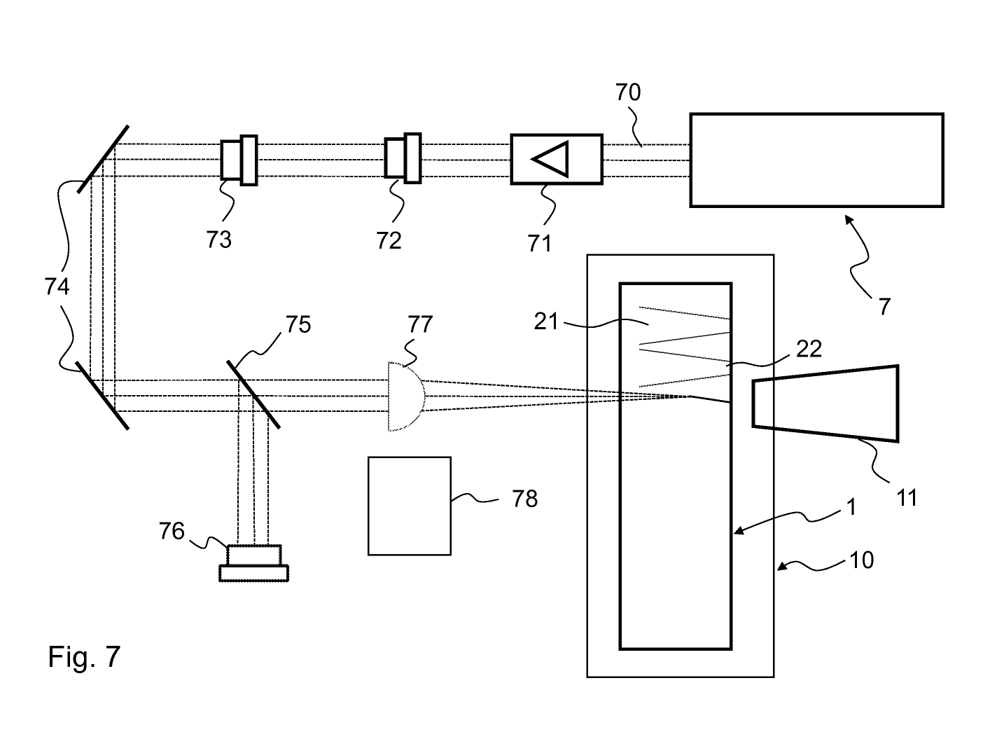

FIG. 7 illustrates a system for producing light concentrators with inner boundary faces of channels. Parts of the system similar to those of FIG. 6 are designated with the same reference numerals. As above, a control means 78 is provided for controlling laser 7, power meter 76, and fine adjustable workpiece holder 10. Laser 7 is a pulsed UV laser (λ=351 nm), for example, with high energy density of greater than 100 J/cm². Pulse widths range from 100 fs to 10 ns. Microscope objective lens 77 has parameters of 50×, NA=0.8. However, other types of lasers with laser emission in a wavelength range from 180 nm to 2000 nm may also be used.

Starting with a light conducting body of a transparent dielectric material, in particular glass, glass ceramics, opto-ceramics, or crystal, light concentrators are produced with inner boundary faces comprised of dot positions of locally modified refraction index using the system of FIG. 5. Laser radiation 50 of a sufficient field strength is focused on a point 12 which is located at a cutting point between the inclined lateral surfaces 23 of the light conducting cell 2 and the minor base 22 of a light conducting cell 2. The high field strength at the focal point leads to a local increase of density of the material involving an increase in refraction index at this dot position, and to a reduction of density around this point of densification involving a reduced refraction index, i.e. a dot position with locally modified refraction index. Then the workpiece holder 10 is displaced in parallel to the upper or lower surface of the light conducting body in y- or z-direction by a distance shorter than the wavelength of the operating light with which the light concentrator is intended to be used. A laser flash is emitted, thereby again creating a dot position with locally modified refraction index. In this manner, dot positions are lined up by “writing” them until a line along or in parallel to an edge between an inclined lateral surface 23 and the minor base 22 has been completed. Thereafter, the workpiece is displaced in the x-direction by an amount smaller than the wavelength of the operating light with which the light concentrator is intended to be used. The creation of new dot positions by “writing” continues along a line which extends along the y- or z-axis, depending on the inclined lateral surface 23 of the truncated pyramid currently being formed. Once all inclined surfaces of a truncated pyramid have been formed in this way, creation of a new light conducting cell starts.

The laser irradiation altered the etch selectivity of the material at the boundary faces produced. By wet chemical etching of the light conducting body, roughnesses may be reduced and, thus, total reflection properties of the inner boundary faces may be enhanced.

Light concentrators made of glass, glass ceramics, opto-ceramics, or crystal and with nanocracks along the inner boundary faces of the light conducting cells may be produced using the system of FIG. 6. Microcracks are caused by very high powers of greater than 1 MW/cm². If microcracks of excessive cross sections are produced, undesirably strong light scattering of the operating light will be caused in the finished light concentrator. To avoid this, short wavelength light in the UV region is used at a wavelength of less than 360 nm to create “nanocracks”, which may be achieved using a frequency-tripled Nd:YAG laser (λ=354.6 nm) or a XeF laser with an operating wavelength of 351 nm. In this case, a threshold of greater than 2 J/cm² at pulse widths of 1 ps should be exceeded. Also, it is possible to cause two focused beams 60, 70 to cross each other at the nanocrack to be created, as illustrated in FIG. 6. In this manner cracks with a dimension of less than 400 nm are obtained, so that the term “nanocrack” is justified. The dot positions of small dimension as specified define in their entirety the inner boundary faces at which the operating light is mostly reflected and only slightly scattered. For use of the light concentrator in the IR spectral range, the employed laser wavelength may be greater. Advantageously, a laser wavelength is employed that is smaller than the wavelength of the operating light. Therefore, it is also possible to use other types of lasers with a laser emission in a range of wavelengths from 180 to 2000 nm.

As in case of FIG. 5, in FIG. 6 again the creation of nanocracks as structuring elements starts in the vicinity of the minor base 22 so that any gases produced can be sucked out. The inclined lateral surfaces 23 are produced by being written, i.e. point by point and line by line is run through until the inner boundary faces are completed. This is performed with a sufficiently small pitch of the dots or nanocracks from one another, as a function of the wavelength of the light applied in the finished light concentrator or distributor. The dot pitch should be in the range of the applied light or smaller, and it is smaller than 500 nm, preferably smaller than 100 nm and more preferably smaller than 20 nm.

As in case of FIG. 5, in FIG. 6 again the light conducting body including the dot-shaped or nanocrack-like structuring elements may be subjected to wet chemical anisotropic etching in order to enhance the light deflecting effect of the inner boundary faces.

The creation of inner boundary faces of wall structures of channels will be explained with reference to FIG. 7. As in case of FIG. 5, in FIG. 7 again the processing of the light conducting body made of glass, glass ceramics, opto-ceramics, or crystal starts near minor base 22. Laser 7 is a pulsed UV laser with λ=351 nm, for example, since with UV-radiation the absorption of light in glass is very high. Energy density is chosen in a range of greater than 100 J/cm². Useful pulse widths are in a range from 100 fs to 10 ns. As in case of the processing in FIG. 5, in FIG. 7 again the creation of the inner wall structures starts near minor base 22. The channels are produced line by line in the x-, y-, or z-direction by laser ablation thereby obtaining the inclined lateral surfaces 23 of the light conducting cells 2. Vapors produced during laser ablation are removed by suction means 11.

As indicated in FIG. 7, the major base 21 is located at some distance from the surface of light conducting body 1. In this way it is avoided that the light conducting body is excessively weakened mechanically. This measure of spacing the major base from the upper surface of the light conducting body may also be applied in the embodiments according to the manufacturing methods of FIGS. 5 and 6. Moreover, the channels formed with the apparatus of FIG. 7 may also be subjected to wet chemical anisotropic etching.

It is also possible for the inclined lateral surfaces 23 of light conducting cells 2 to be treated using saws, abrasives and polishing agents, once the light conducting cell material has been weakened along the intended boundary faces. The weakening may be accomplished by laser irradiation, optionally also by additional etching.

The creation of the inner inclined boundary faces 23 by using focused laser radiation perpendicular to the surface of the light conducting body is not a necessity, it is also possible to have the direction of the laser beam coincide with the inclination of the inner boundary faces 23, which will result in a smoothing of these boundary faces in spite of their creation in form of dots. This may be important in particular when producing the boundary faces by channels according to FIG. 7.

In principle, all transparent dielectric materials are suitable as the starting material for the transparent light conducting bodies, whether organic or inorganic in nature.

### Examples of Organic Materials Include:

Plastics (polymers): thermoplastics (non-crystalline, partially crystalline, or crystalline); thermosets, elastomers, thermoplastic elastomers; cyclic olefin copolymers (COC).

### Examples of Inorganic Materials Include:

Silicate glasses (e.g. silica glasses (many variants, in particular types I, II, III, and IV, i.e. molten from quartz, synthetically produced from SiF₄, etc.); alkali silicate glasses; alkali alkaline-earth silicate glasses (e.g. soda-lime silicate glasses, or sodium-potassium-lime silicate glasses, i.e. mixed-alkali lime silicate glasses, or mixed-alkali strontium silicate glasses, mixed-alkali barium silicate glasses etc.); borosilicate glasses (e.g. Schott's glasses DURAN, FIOLAX, SUPRAX . . . , in particular iron-poor variants thereof); phosphosilicate glasses (e.g. Schott's SUPREMAX glass); borophospho silicate glasses; aluminosilicate glasses (e.g. alkali-aluminosilicate glasses, alkali alkaline-earth aluminosilicate glasses, etc., such as Corning's GORILLA variants, or Schott's XENSATION glass); boro-aluminosilicate glasses, in particular alkali-free glasses, e.g. Corning's EAGLE glasses; borophospho aluminosilicate glasses; various other glasses, e.g. those which include further minority components or special refining agents; all of the above and other glasses, but not produced in a melting process rather by any of the many sol-gel processes).

Borate glasses.

Phosphate glasses.

Fluorophosphate glasses (which are generally optical glasses);

Other optical glasses (those with “standard components”, (e.g. Schott's BK7 glass); those with special components such as lead oxide, lanthanum oxide, vanadium pentoxide, etc., e.g. Schott's SF6 glass).

Luminescent glasses (These generally contain rare earths and therefore are luminescent. Such fluorescent or phosphorescent glasses into which the inventive light-deflecting structures are written, combine the function of “light control” and the function of “frequency conversion” or a “laser effect”); laser glasses; conversion glasses; etc.

Solarization-resistant glasses (e.g. ceria-stabilized glasses), in particular optical glasses; space-qualified glasses.

Tellurate- and tellurite glasses.

Halide glasses (generally transparent in the infrared), fluoride glasses (simplest classic case: MgF₂; moreover many complex composition ranges); chloride, bromide, iodine glasses; glasses with several different (halogen) anions; glasses including oxygen as an anion in addition to halogen anions, see e.g. the fluorophosphate glasses already mentioned.

Chalcogenide glasses (generally not transparent in the visible, but often transparent in the infrared up to very large wavelengths); sulfide glasses; selenide glasses; ternary, quaternary, or even more complex glasses, e.g. from the systems Ge—Se—As—Ge, Ge—S—As, Ge—Se—Sb, Ge—S—As, . . . .

Chalcohalide glasses (often transparent in the infrared).

Glass ceramics (which are transparent in the wavelength range of interest).

Glass ceramics (produced from molten “green glasses” by selective thermal partial crystallization): LAS glass ceramics; MAS glass ceramics; BAS glass ceramics; extremely many more with various other components or combinations thereof, e.g. yttrium-containing glass ceramics, glass ceramics containing BaTiO₃, . . . ; very many more, each with a characteristic crystallite size or shape, crystallite size distribution, texture.

Sintered glass ceramics (produced from compacts of glassy and/or already crystalline/semi-crystalline powders): wide variety of glass ceramics similar to those produced from solid green glass. Sintered glass ceramics may include various luminescent materials. The luminescent materials may, for example, be composed of different Eu-doped materials such as CaS:Eu, Sr₂Si₅N₈:Eu, SrS:Eu, Ba₂Si₅N₈:Eu, Sr₂SiO₄:Eu, SrSi₂N₂O₂:Eu, SrGa₂S₄:Eu, SrAl₂O₄:Eu, Ba₂SiO₄:Eu, Sr₄Al₁₄O₂₅:Eu, SrSiAl₂O₃N:Eu, BaMgAl₁₀O₁₇:Eu, Sr₂P₂O₇:Eu, SrB₄O₇:Eu, Y₂O₃:Eu, YAG:Eu, Ce:YAG:Eu, (Y,Gd)BO₃:Eu, (Y,Gd)₂O₃:Eu. Luminescent materials may be co-doped or may be doped with other rare earth elements (scandium, yttrium, lanthanum, cerium, praseodymium, neodymium, promethium, samarium, gadolinium, terbium, dysprosium, holmium, erbium, thulium, ytterbium, and lutetium) (e.g. LaPO₄:Ce,Tb, LaMgAl₁₁O₁₉:Ce,Tb, (Y,Gd,Tb,Lu)AG:Ce, Lu₃₋ₓ₋₂AₓA_{5-y-z}Sc_{y}O₁₂:Mn₂Ca_{z}, Lu₂SiO₅:Ce, Gd₂SiO₅:Ce, Lu_{1-x-y-a-b}YₓGd_{y})₃ (Al_{1-z}Ga)₅O₁₂:CeₐPr_{b}). Cost efficient luminescent materials for VUV excitation include LaPO₄:Pr, YPO₄:Pr, (Ca,Mg)SO₄:Pb, LuBO₃:Pr, YBO₃:Pr, Y₂SiO₅:Pr, SrSiO₃:Pb, LaPO₄:Ce, YPO₄:Ce, LaMgAl₁₁O₁₉:Ce. When excited by X-rays, the following exemplary luminescent materials may be used: InBP₃:Tb+InBO₃:Eu, ZnS:Ag, Y₂O₂S:Tb, Y₂SiO₅:Tb, Y₃(Al,Ga)₅O₁₂:Ce, (Zn,Cd)S:Cu,Cl+(Zn,Cd)S:Ag,Cl, Y₃(Al,Ga)₅O₁₂:Tb, Zn₂SiO₄:Mn, Zn₈BeSi₅O₁₉:Mn, CaWO₄:W, Y₂O₂S:Eu+Fe₂O₃, (Zn,Mg)F₂:Mn, Y₃Al₅O₁₂:Tb.

Opto-ceramics (These generally include ceramics produced by sintering, which are transparent in the relevant wavelength range, i.e. which have very small grains and/or refraction index matched grain boundaries. Opto-ceramics usually have a polycrystalline structure.): spinel opto-ceramics; pyrochlore opto-ceramics; YAG opto-ceramics; LuAg opto-ceramics; yttria opto-ceramics; ZnSe:Te opto-ceramics, GOS:Pr, Ce, F, YGO:Eu, Tb, Pr, GGG:Cr, Ce; rare earths-containing (Y, Gd, Tb, Dy, Ho, Er, Tm, Yb, Lu, Sc, La, Ce, Pr, Nd, Pm, Sm, Eu) and therefore active opto-ceramics.

Crystals (single crystals): sapphire (Al₂O₃); other oxides, e.g. ZrO₂; spinel (various compositions/mixture series); pyrochlore (very many compositions/material systems); CaF.

Many of the materials listed above are sufficiently transparent not only in the visible, but more or less far also in the infrared. Thus, similar structures that are optically effective in the IR can be written into those materials using the methods of the invention, for which, in turn, infrared lasers will suffice as tools. Due to the longer wavelengths, spot sizes and structuring may be coarser in this case.

Some of the materials listed above, e.g. silica glasses or very iron-poor glasses, are even sufficiently transparent more or less far in the ultraviolet. Accordingly, structures that are optically effective in the UV can be written into those materials using the methods of the invention, however, in this case the spot size has to be smaller and the structuring has to be finer. Some of the listed materials are suitable to convert portions of the light spectrum to a different wavelength or wavelength spectrum. On the one hand, this allows to increase the efficiency of solar cells, since the efficiency of solar cells is a function of the wavelength. On the other hand, it is possible to convert X-ray light into visible light. When using light sources such as LEDs, OLEDs, or lasers, the emitted light may be converted to a different wavelength or a different wavelength spectrum.

What is claimed is:

1. A light concentrator or distributor for focusing light onto a plurality of light receiving elements or for spreading and collimating light from small area light sources, comprising:
a transparent light conducting body of a transparent dielectric material, the light conducting body having a plurality of light conducting cells in an interior of the light conducting body, the plurality of light conducting cells having a shape selected from the group consisting of truncated pyramids, truncated cones, truncated paraboloids, and conical honeycombs, each shape having a major base, a minor base, and lateral surfaces that are formed as inner boundary faces within the light conducting body;
wherein the inner boundary faces are capable of directing light incident to each of the light conducting cells onto one of the major and minor bases of the respective light conducting cell by diffraction, reflection, or total reflection; and
wherein the inner boundary faces of the respective light conducting cell are defined by one of refraction index jumps in the light conducting body, dot-shaped structuring elements within the transparent dielectric material of the light conducting body, and nanocrack-like structuring elements within the transparent dielectric material of the light conducting body.

2. The light concentrator or distributor as claimed in claim 1, wherein the inner boundary faces of each light conducting cell are defined by air gaps.

3. The light concentrator or distributor as claimed in claim 1, wherein the inner boundary faces of each light conducting cell are defined by wall structures of channels.

4. The light concentrator or distributor as claimed in claim 3, wherein the channels of each light conducting cell are produced by removal of material using a laser and are enlarged by etching.

5. The light concentrator or distributor as claimed in claim 1, wherein the light conducting cells are disposed in one or more rows, and wherein the transparent light conducting body is provided in the form of a rod or a plate including one or more rows of light conducting cells.

6. The light concentrator or distributor as claimed in claim 5, wherein each light conducting cell or each row of light conducting cells has associated therewith an optical lens.

7. A lighting device, comprising a small area light source and a light concentrator or distributor according to claim 1, wherein the small area light source comprises at least one source selected from the group consisting of an LED, an OLED, and a laser, and wherein the small area light source is disposed at the minor base and emits light in a specific wavelength range.

8. The lighting device as claimed in claim 7, wherein the transparent dielectric material of the light conducting body is doped with a fluorescent material to absorb portions of the incident light of the specific wavelength range and to emit light at a different wavelength range.

9. The lighting device as claimed in claim 8, wherein the absorbed portion of the incident light is not more than 50%.

10. A photovoltaic or photodetector device, comprising a single or a plurality of photovoltaic cells or of photodetectors, and a light concentrator or distributor according to claim 1, wherein the photovoltaic cell or the photodetector is disposed at the minor base of the light conducting cell.

11. A method for producing a light concentrators or distributors in the form of transparent light conducting bodies, comprising the steps of:
providing a transparent dielectric body as a workpiece having an outer shape of the light conducting body to be produced;
producing channels in the dielectric body along lateral surfaces of a shape selected from the group consisting of truncated pyramids, truncated cones, truncated paraboloids, and conical honeycombs by using preparatory supportive laser irradiation to define inner boundary faces of light conducting cells; and
subsequently etching the dielectric body along the laser-irradiated inner boundary faces.

12. The method of claim 11, further comprising treating the inner boundary faces of the light conducting cells using at least one of saws, abrasives, and polishing agents.

13. The method as claimed in claim 11, wherein pulsed laser radiation having a wavelength in a range from 180 nm to 2000 nm and a power density of more than 100 J/cm² is applied along channels to be produced in the workpiece.

14. A method for producing light concentrators or distributors in the form of transparent light conducting bodies comprising a plurality of light conducting cells that are delimited by inner boundary faces which form lateral surfaces of a shape selected from the group consisting of truncated pyramids, truncated cones, truncated paraboloids, an conical honeycombs, comprising the steps of:
providing a transparent dielectric body as a workpiece having the outer shape of the light concentrator or distributor;
focusing laser radiation onto a dot position to be written of a lateral surface of the light conducting cell to be produced and creating a structuring element at the dot position;
adjusting the workpiece relative to the focused laser radiation to another dot position to be written of the lateral surface of the light conducting cell being produced;
repeating steps the focusing and adjusting steps for ever new dot positions to be written of the light conducting cell being produced until it is completed;
focusing laser radiation onto a dot position to be written of a lateral surface of a further light conducting cell and creating a structural element at the dot position; and
adjusting the workpiece relative to the focused laser radiation to another dot position to be written of the lateral surface of the further light conducting cell being produced.

15. The method as claimed in claim 14, wherein a dot pitch of the dot position is smaller than 500 nm.

16. The method as claimed in claim 14, wherein a dot pitch of the dot position is smaller than 20 nm.

17. The method as claimed in claim 14, wherein pulsed laser radiation with a wavelength in a range from 180 nm to 2000 nm and an energy density of more than 2 J/cm² at the dot positions to create nanocracks.

18. The method as claimed in claim 17, wherein the dot positions are treated by laser radiation from two laser sources.

19. An apparatus for performing the method according to claim 14, comprising:
a laser for emitting laser radiation of a predefined intensity;
a microscope objective lens for focusing the laser radiation onto a focal point within a dielectric body as a workpiece;
a workpiece holder adapted for fine positioning of the workpiece relative to the focal point of the laser radiation and for controlled displacement of the workpiece; and
a controller with a power meter the laser radiation for controlling and regulating the laser in terms of pulse output and radiation intensity, and for controlling the workpiece holder to write lines of dot positions into the workpiece along inclined lateral surfaces of truncated pyramids, truncated cones, truncated paraboloids, or conical honeycombs to define light conducting cells, wherein an amount of displacement settable in the light conducting body being produced is less than the wavelength of the operating light.

20. The apparatus as claimed in claim 19, wherein the amount of displacement is smaller than 500 nm.

21. The apparatus as claimed in claim 19, wherein the laser is a Ti:Al₂O₃ laser (5) having a pulse width of less than 100 fs and a wavelength in a range from 180 nm to 2000 nm.

22. The apparatus as claimed in claim 19, wherein the laser is an XeF laser or an Nd:YAG laser having a pulse width in a range around 1 ps and a wavelength in a range from 180 nm to 400 nm.

23. The apparatus as claimed in claim 19, wherein the laser is an XeF laser having a pulse width in a range from 100 fs to 10 ns and a wavelength in a range from 180 nm to 400 nm.
